(19) United States
(12) Patent Application Publication
(10) Pub. No.: US 2011/0228315 A1
(43) Pub. Date: Sep. 22, 2011

(54) PROCESSING APPARATUS AND COMPUTER READABLE MEDIUM

(75) Inventor: Akio ARAI, Kanagawa (JP)

(73) Assignee: FUJI XEROX CO., LTD., Tokyo (JP)

(21) Appl. No.: 12/857,027

(22) Filed: Aug. 16, 2010

(30) Foreign Application Priority Data
Mar. 18, 2010 (JP) 2010-062035

(51) Int. Cl. G06F 3/12

(52) U.S. Cl. 358/1.15

(57) ABSTRACT

A processing apparatus includes: an acquisition unit that acquires image data by reading an image from an original; a selection unit that operationally selects either one of storing the image data into a portable storage unit or sending the image data to a storage device capable of taking out the data via a communication unit, wherein when the storing is selected, the selection unit further operationally selects at least any one of deleting data already stored in the portable storage unit and moving the image data to the storage device; and a data processing unit that performs based on result selected by the selection unit.

### CROSS-REFERENCE TO RELATED APPLICATION

This application is based on and claims priority under 35 USC 119 from Japanese Patent Application No. 2010-062035 filed on Mar. 18, 2010.

### BACKGROUND

### Technical Field

The present invention relates to a processing apparatus and a computer readable medium.

### SUMMARY

According to an aspect of the invention, a processing apparatus includes:

an acquisition unit that acquires image data by reading an image from an original;

a selection unit that operationally selects either one of storing the image data into a portable storage unit or sending the image data to a storage device capable of taking out the data via a communication unit, wherein when the storing is selected, the selection unit further operationally selects at least any one of deleting data already stored in the portable storage unit and moving the image data to the storage device; and

a data processing unit that performs at least any one of deleting the data already stored in the portable storage unit and moving the image data to the storage device, and performs either one of storing the image data into the portable storage unit or sending the image data to the storage device, based on selected result of the selection unit.

### BRIEF DESCRIPTION OF THE DRAWINGS

Exemplary embodiments of the invention will be described in detail based on the following figures, wherein:

FIG. 1 is a block diagram showing the schematic configuration of an image processing system according to a first exemplary embodiment of the invention;

FIG. 2 is a flowchart showing a process of a system control part;

FIG. 3 is a view showing a display example of a selection screen for various kinds of process on a display section of an operation panel;

FIG. 4 is a flowchart showing a subroutine of the processing at step S28;

FIG. 5 is a view showing an example of send data information;

FIG. 6 is a flowchart showing a process for downloading the data transmitted to a server into a PC, in which this process is performed on the side of the PC;

FIG. 7 is a flowchart showing a process for downloading the data sent to the server into the PC, in which this process is performed on the server side;

FIG. 8 is a flowchart showing a process according to a second exemplary embodiment;

FIG. 9 is a flowchart showing a specific example of the processing at steps S128 and S129;

FIG. 10 is a view showing a display example in which the free space of a USB memory after sending the data is smaller than the data size of image data;

FIG. 11 is a view showing a display example in which the free space of the USB memory after sending the data is larger than the data size of image data; and

FIG. 12 is a flowchart showing a process of a comparative example.

### DETAILED DESCRIPTION

An image processing system according to a first embodiment of the present invention will be described below.

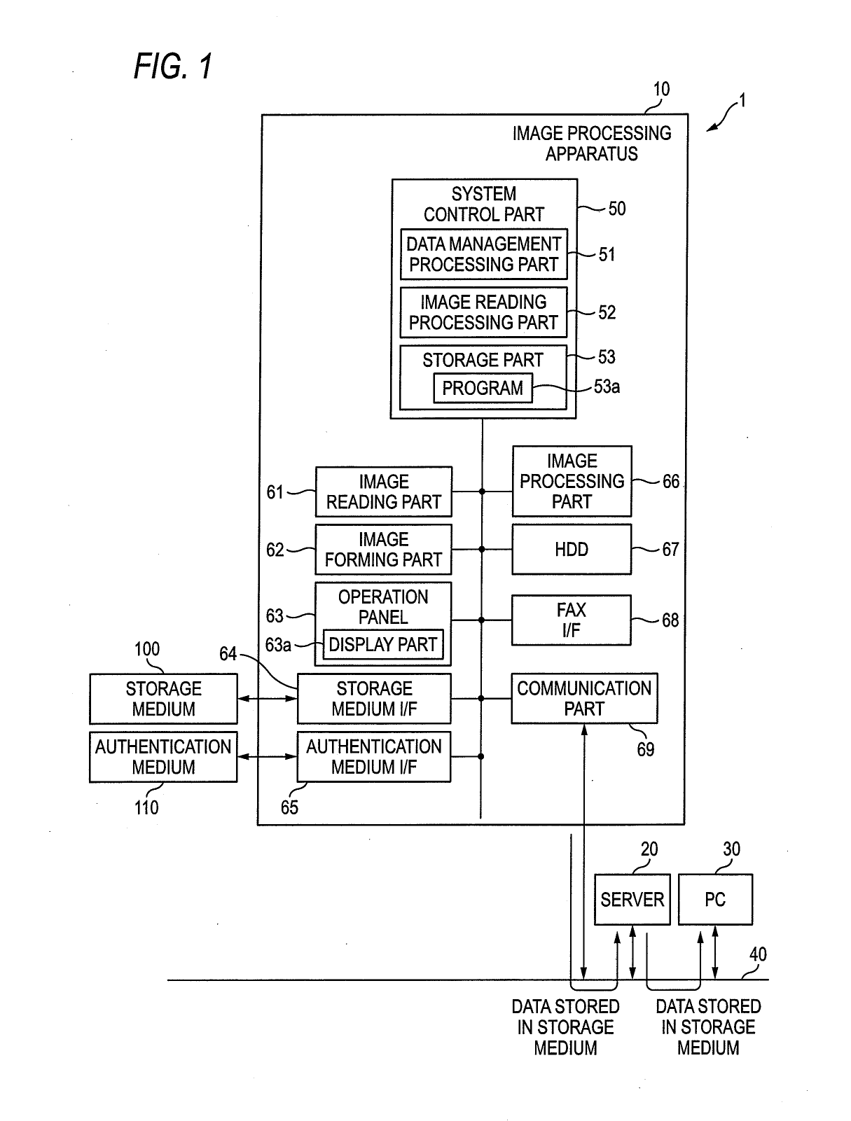

FIG. 1 is a block diagram showing the schematic configuration of an image processing system 1 according to the first embodiment. The image processing system 1 has an image processing apparatus 10, a server 20, and a PC (personal computer) 30, as shown in FIG. 1. In this image processing system 1, the image processing apparatus 10, the server 20 and the PC 30 are connected to be communicable via communication means 40 such as a LAN (Local Area Network) or internet.

The image processing apparatus 10 has a system control part 50, an image reading part 61, an image forming part 62, an operation panel 63, a storage medium I/F (interface) 64, an authorization medium I/F 65, an image processing part 66, an HDD 67, a FAX I/F 68 and a communication part 69.

The system control part 50 controls various kinds of process in the overall image processing apparatus 10. The image reading part 61 reads an image from an original to generate the image data. The image processing part 66 performs various kinds of image processing such as shading correction for the image data generated by the image reading part 61. The HDD 67 stores the image data processed by the image processing part 66. The image forming part 62 forms an image on the printing medium, based on the image data, using a printing device, not shown in the drawings. For example, the printing device forms the image on the printing medium by a printing method such as photo-electrographic or ink jet recording method.

The operation panel 63 has integrally a display section (display screen) 63a for displaying the content notified to the user and an input part for inputting the content instructed by the user. The storage medium I/F 64 has a shape for mounting or dismounting a storage medium 100, and sends or receives the data to or from the mounted storage medium 100. The authentication medium I/F 65 sends or receives the data to or from an authentication medium (e.g., ID card) 110. The FAX I/F 68 makes the facsimile communication using the general public line.

The communication part 69 sends or receives the data to or from the communication means 40.

The server 20 has a storage device for managing various kinds of data. For example, the server 20 manages various kinds of data such as image data transmitted from the image processing apparatus 10 via the communication means 40. Also, the server 20 may send or receive the data to or from the PC 30 connected to the communication means 40.

In the image processing system 1 with the above configuration, the image processing apparatus 10 may store the image data acquired by reading the original in the image reading part 61 into the storage medium 100 (e.g., a USB memory) mounted on the storage medium I/F 64.

And if the free space of the storage medium is smaller than the acquired image data, the image data may be stored in the storage medium after deleting the data stored in the storage medium.

However, with such configuration, if the data stored in the storage medium 100 may not be deleted because it is important, the image data may not be stored in the storage medium 100.

On the contrary, in this embodiment, even if the free space of the storage medium 100 is smaller than the acquired image data, the image data may be stored in the storage medium 100 without erasing the data stored in the storage medium 100.

The configuration for realizing this embodiment will be described below.

The system control part 50 has a data management processing part 51, an image reading processing part 52 and a storage part 53, as shown in FIG. 1.

The storage part 53 stores a program 53a and the data for use in the image processing apparatus 10.

Herein, it is supposed that the program 53a is pre-stored in the storage part 53 before shipment of the image processing apparatus, or the program 53a is stored in the storage part 53 by installing a storage medium such as a CD-ROM after using the image processing apparatus by a user.

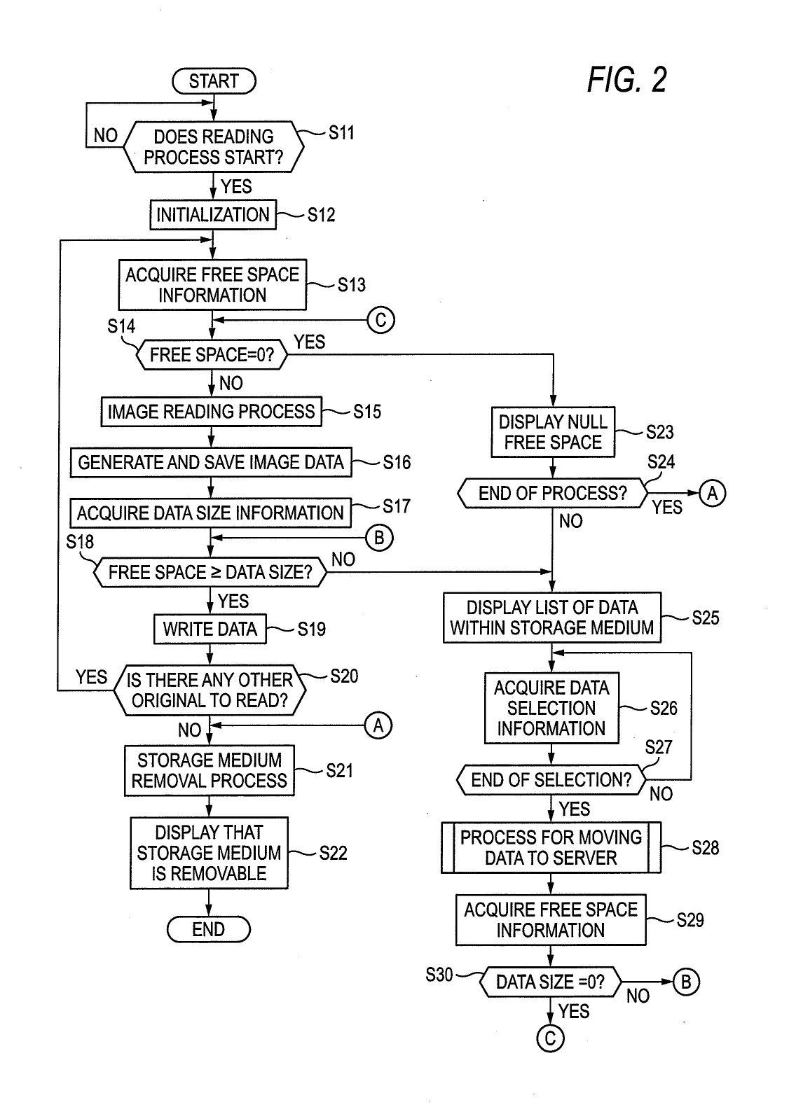

FIG. 2 is a flowchart showing a process of this system control part 50. Referring to FIG. 2, the process of the system control part 50 will be described below in connection with each component of the system control part 50 as shown in FIG. 1.

At step S11, first of all, the image reading processing part 52 determines whether or not the user executes the processor of reading the image, based on an input from the operation panel 63, as shown in FIG. 2.

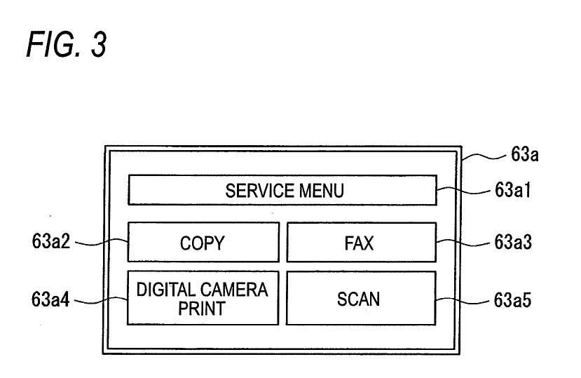

FIG. 3 shows a display example of a selection screen for various kinds of process on the display section 63a of the operation panel 63. A “service menu” 63a1, including a “copy” 63a2, a “FAX” 63a3, a “digital camera print” 63a4 and a “scan” 63a5, is displayed on the display section 63a of the operation panel 63, as shown in FIG. 3. If the “scan” 63a5 (reading process) is selected on this display screen, the image reading processing part 52 determines that the execution of reading the image is selected.

If the image reading processing part 52 determines that the execution of reading the image is selected at step S11, the procedure goes to step S12.

At next step S12, the image reading processing part 52 initializes the register or memory relevant to the image reading process.

At next step S13, the data management processing part 51 acquires the information on the free space of the storage medium 100 (e.g., USB memory) mounted on the storage medium I/F 64.

For example, when the “scan” is selected on the display screen as above described, there appears an indication for prompting the user to mount the storage medium on the mount part of the image processing apparatus 10 on the display screen. Correspondingly, the user mounts the storage medium such as storage medium 100 on the mount part of the image processing apparatus 10.

At next step S14, the data management processing part 51 determines whether or not the free space acquired at step S13 is null. If the data management processing part 51 determines that the free space is null, the procedure goes to step S23. Also, if the data management processing part 51 determines that the free space is not null, the procedure goes to step S15.

At step S15, the image reading processing part 52 performs an image reading process.

At next step S16, the image reading processing part 52 generates the image data (image file) of the image read at step S15 and saves the generated image data in the HDD 67. At this time, the image reading processing part 52 controls the image processing part 66 to perform various kinds of image processing for the image data generated by the image reading part 61. Also, a saving destination of the image data may select a work memory.

At next step S17, the data management processing part 51 acquires the information on the data size (data capacity) of the image data saved at step S16.

At next step S18, the data management processing part 51 determines whether or not the free space of the storage medium 100 acquired at step S13 is larger than or equal to the data size (total data size) of image data acquired at step S17. If the data management processing part 51 determines that the free space of the storage medium 100 is larger than or equal to the data size of image data (free space≧data size), the procedure goes to step S19. Also, if the data management processing part 51 determines that the free space of the storage medium 100 is smaller than to the data size of image data (free space<data size), the procedure goes to step S25.

At step S19, the data management processing part 51 writes the image data saved at step S16 into the storage medium 100.

At next step S20, the image reading processing part 52 determines whether or not there is any other original to read. If the image reading processing part 52 determines that there is any other original to read, for example, when the user starts the reading again, the process starts again from step S13. Also, if the image reading processing part 52 determines that there is no other original to read, the procedure goes to step S21.

At step S21, the data management processing part 51 performs a processing for making the storage medium 100 removable when writing the image data into the storage medium 100 is ended.

At next step S22, the data management processing part 51 displays an indication that the storage medium 100 becomes removable on the display section 63a of the operation panel 63 when the processing of making the storage medium 100 removable is ended.

On the other hand, at step S23, the data management processing part 51 displays an indication that there is no free space of the storage medium 100 on the display section 63a of the operation panel 63. And the data management processing part 51 displays a prompt of enabling the user to select whether or not the reading process is ended on the display section 63a of the operation panel 63, together with that indication.

At next step S24, the data management processing part 51 determines whether or not the user makes an operation of ending the reading process, based on the input from the operation panel 63. If the data management processing part 51 determines that the user makes the operation of ending the reading process, the procedure goes to step S21. Also, if the data management processing part 51 determines that the user does not make the operation of ending the reading process, that is, when the user makes the operation of continuing the reading process, the procedure goes to step S25.

At step S25, the data management processing part 51 displays on the display section 63a of the operation panel 63 a list of information of already stored data (such as data name) to enable the user to select the data to be moved to the server 20 from the data already stored within the storage medium 100 (hereinafter the already stored data). At this time, the data management processing part 51 displays the list of information so that the user may select the data from the list.

At following steps S26 and S27, until the data management processing part 51 determines that the user makes the operation of ending the selection of data, for example, until the user ends or decides the selection of data on the operation panel 63, the data management processing part 51 acquires the information of selected data, based on the input from the operation panel 63. And if the data management processing part 51 determines that the selection of data is ended, the procedure goes to step S28.

At step S28, the data management processing part 51 performs a process for moving (sending) the data selected at step S26 to the server 20. This process will be described later.

At next step S29, the data management processing part 51 acquires again the information on the free space of the storage medium 100.

At next step S30, the data management processing part 51 determines whether or not the data size of image data saved in the HDD 67 is null. If the data management processing part 51 determines that the data size of image data saved in the HDD 67 is null, the process starts again from step S14 to start reading the original. Also, if the data management processing part 51 determines that the data size of image data saved in the HDD 67 is not null, that is, when the original is already read, the process starts again from step S18.

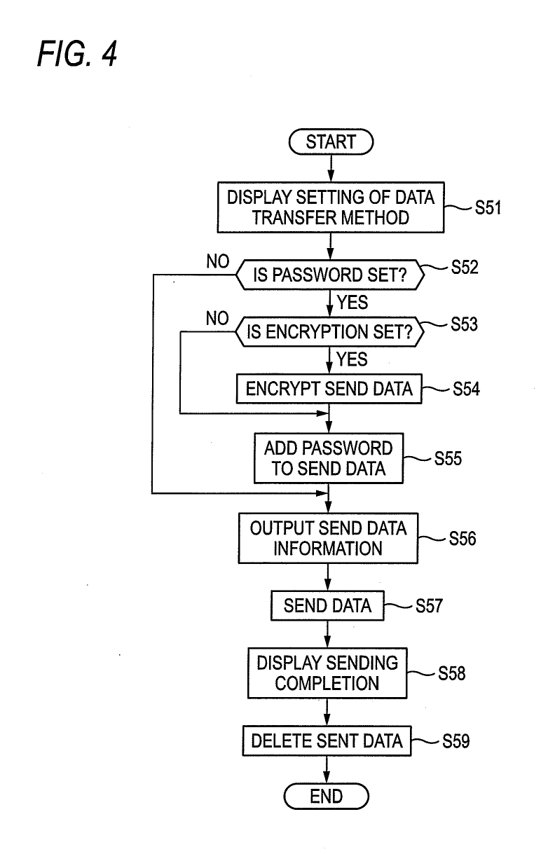

FIG. 4 is a flowchart showing a subroutine of the processing at step S28.

At step S51, first of all, the data management processing part 51 displays an indication of prompting the user to set the data sending method on the display section 63a of the operation panel 63, as shown in FIG. 4. Specifically, the data management processing part 51 displays the information on the data sending method of sending the data from the image processing apparatus 10 to the server 20, including the presence or absence of setting the password, the password to be set, and the presence or absence of encryption so that the user may set it.

At this time, the user may be asked to set the e-mail address as the ID.

At next step S52, the data management processing part 51 determines whether or not the selection of setting the password is made based on the information set at step S51. If the data management processing part 51 determines that the selection of setting the password is made, the procedure goes to step S53. Also, if the data management processing part 51 determines that the selection of setting the password is not made, the procedure goes to step S56.

At step S53, the data management processing part 51 determines whether or not the encryption is made based on the information set at step S51. If the data management processing part 51 determines that the encryption is made, the procedure goes to step S54. Also, if the data management processing part 51 determines that the encryption is not made, the operation skips step S54 and goes to step S55.

At step S54, the data management processing part 51 encrypts the data based on the password set at step S51.

At next step S55, the data management processing part 51 adds the password set at step S51 to the send data. The data management processing part 51 further adds the password to the encrypted data if the data is encrypted (step S54).

At next step S56, the data management processing part 51 outputs the send data information. Specifically, the data management processing part 51 outputs the printing medium with the send data information printed from the printing device in accordance with the user's operation.

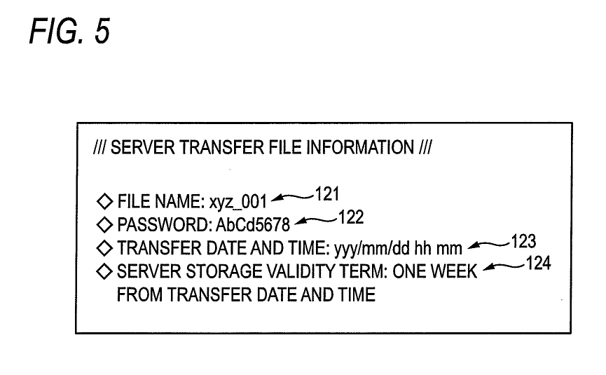

FIG. 5 shows an example of send data information outputted from the printing device or monitor.

The send data information includes a “file name” (data name) 121, a “password” 122, a “transfer date and time” 123 and a “server storage validity term” 124, as shown in FIG. 5.

At next step S57, the data management processing part 51 sends the data selected at step S26 or the data to which the password is added at step S55 to the server 20.

At next step S58, the data management processing part 51 displays an indication that the data transmission is completed on the display section 63a of the operation panel 63, when the data transmission to the server 20 is completed.

At next step S59, the data management processing part 51 deletes the already stored data within the storage medium 100 corresponding to the send data.

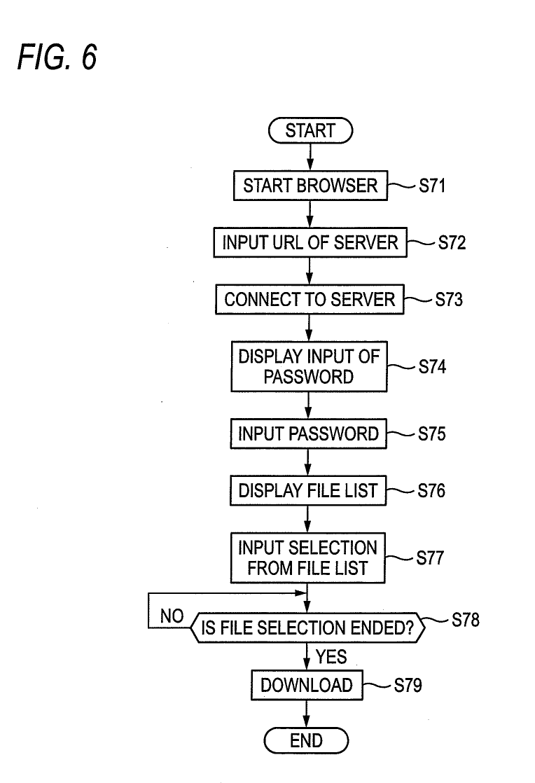

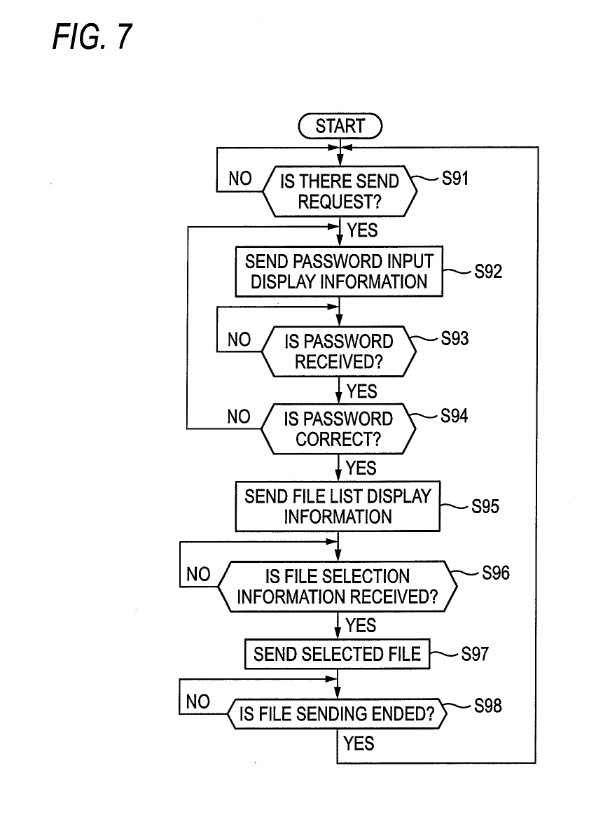

FIGS. 6 and 7 are flowcharts showing a process for downloading the data sent to the server 20 into the PC 30. FIG. 6 shows the process on the side of the PC 30 and FIG. 7 shows the process on the side of the server 20.

The process on the side of the PC 30 is firstly described below. At steps S71 to S73, first of all, an interne browser starts up on the PC 30, and if the URL of the server 20 is inputted, the PC is connected to the server 20, as shown in FIG. 6.

On the PC 30, a password input indication appears on the monitor at step S74. If the password is inputted at step S75, a file list is displayed on the monitor at step S76. Herein, if the ID (e.g., e-mail address) is set in sending the data from the image processing apparatus 10 to the server 20, it is required to input the ID together with the password.

On the PC 30, a file is selected from the file list at step S77, and if the selection of the file is ended at step S78, the selected file is downloaded at step S79.

On the other hand, on the side of the server 20, the server 20 is in a state waiting for a file send request at step S91, and if there is a send request, the password input indication information for presenting the password input indication is sent to the PC 30 making the send request at step S92, as shown in FIG. 7.

The server 20 receives the password sent from the PC 30 at step S93, and determines whether or not the password is correct at step S94. For example, the server 20 manages the file received from the image processing apparatus 10 together with the password, and compares it with the password sent from the PC 30. If the server 20 determines that the password is correct, the procedure goes to step S95. Also, the server 20 determines that the password is incorrect, the process starts again from step S92 to re-input the password.

At step S95, the server 20 sends the file list display information for displaying the file list of selectable files on the monitor to the PC 30.

And the server 20 receives the file selection information at step S96, and sends the file according to the file selection information to the PC 30 at step S97. Thereafter, the server 20 is put in a state waiting for a file send request by returning to step S91.

The image processing system is configured as above, and the operation is as follows.

If the user starts reading an image, the image processing apparatus 10 reads the image from the original and temporarily stores the image data in the HDD 67 (steps S11, S12, S15 and S16). And the image processing apparatus 10 acquires the data size of the image data (step S17).

If the free space of the storage medium 100 mounted in the storage medium I/F 64 acquired ahead is larger than or equal to the data size of the image data, the image processing apparatus 10 writes the image data into the storage medium 100, and performs a process for enabling the user to remove the storage medium 100 when there is any other reading original (steps S13, S18 to S22).

Also, if the free space of the storage medium 100 is null, the image processing apparatus 10 displays an indication that there is no free space of the storage medium 100 on the display section 63a of the operation panel 63 (step S23), and performs the process for enabling the user to remove the storage medium 100 (steps S21 and S22) when the user performs an operation of ending the reading process (step S24). On the other hand, if the user does not continue the reading process (step S24), the image processing apparatus 10 displays a data list for enabling the user to select the data to be moved to the server 20 from the already stored data within the storage medium 100 (step S25). Also, if the free space of the storage medium 100 is smaller than the data size of the image data, the image processing apparatus 10 displays this data list as well (steps S18 and S25). From the display of this data list, the user may know that the image data may not be stored in this storage medium 100 because the free space of the storage medium 100 is smaller. If the user selects the data to be moved to the server 20 corresponding to the display of such data list (steps S26 and S27), the image processing apparatus 10 performs a process for moving (sending) the selected data to the server 20 (step S28, see FIG. 4). And the image processing apparatus 10 acquires again the information on the free space of the storage medium 100 after moving the data to the server 20 (step S29), and starts again the process based on the acquired free space of the storage medium 100 (step S30).

In this way, the user may take out the data (already stored data stored in the storage medium 100) moved from the image processing apparatus 10 to the server 20 by operating the own PC (see FIGS. 6 and 7).

As described above, in the first embodiment, the image processing apparatus 10 displays the data list of already stored data within the storage medium 100 and reports that the image data may not be stored in the storage medium 100, if the data size of the image data is larger than the free space of the storage medium 100 (step S25).

At this time, the image processing apparatus 10 enables the user to select the already stored data within the storage medium 100 and moves the selected already stored data to the server 20 (steps S25 to S28).

Thereby, the user may acquire the image data without erasing it by moving the already stored data within the storage medium 100 to the server 20 (taking it out on the PC 30 later), even if the free space of the storage medium 100 is smaller.

An image processing system according to a second embodiment of the invention will be described below.

In the second embodiment, if the free space of the storage medium is smaller, the user may select the already stored data within the storage medium to be deleted or sent to the server.

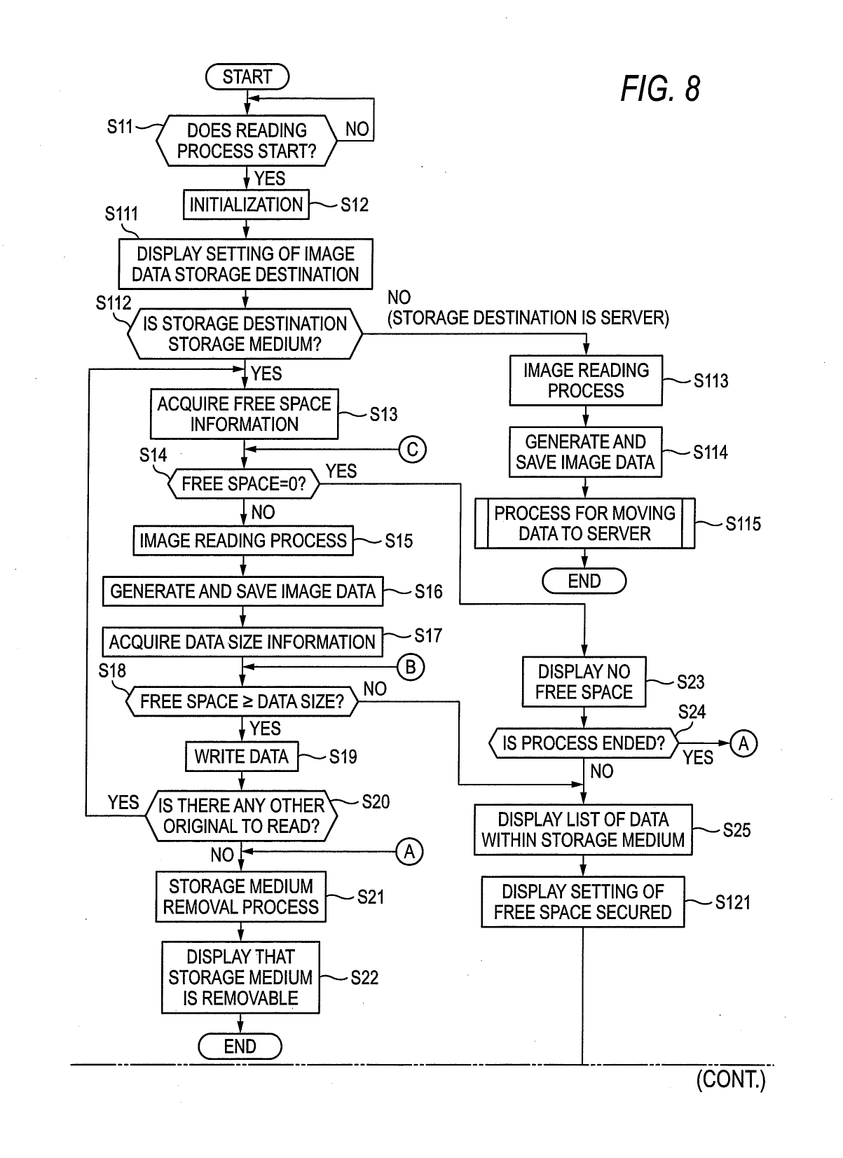

FIG. 8 is a flowchart showing a process according to the second embodiment.

In the process as shown in FIG. 8, the parts with the same reference signs perform the same operations as in the process of FIG. 2 according to the first embodiment, unless specifically noted.

In the second embodiment, the steps S111 to S115, S121 and S130 are added as the new process, as shown in FIG. 8. In the following, this added new process will be mainly described.

At step S111 following step S12, the data management processing part 51 displays a setting screen for enabling the user to set the storage destination of image data on the display section 63a of the operation panel 63. Herein, a choice of the server or the storage medium as the storage destination is displayed on the setting screen.

At next step S112, the data management processing part 51 determines whether or not the storage medium is selected as the storage destination, based on the input information from the operation panel 63. If the data management processing part 51 determines that the storage medium is selected, the procedure goes to step S13. Also, if the data management processing part 51 determines that the server is selected, the procedure goes to step S113.

At step S113, the image reading processing part 52 performs a process for reading the image in the same way as at step S15.

At next step S114, the image reading processing part 52 saves the image data of the image read at step S113 in the HDD in the same way as at step S16.

At next step S115, the data management processing part 51 moves (sends) the image data saved at step S114 to the server 20 in the same way as at step S28 (see FIG. 4).

Also, at step S121 following step S25, the data management processing part 51 displays a setting screen for prompting the user to select a measure for securing the free space on the display section 63a of the operation panel 63. Herein, a choice of a measure for deleting the already stored data within the storage medium or a measure for moving the already stored data to the server is displayed on the setting screen. For example, the data management processing part 51 displays the data within the data list to be selectable and displays the measure for securing the free space at steps S25 and S121.

At next step S122, the data management processing part 51 determines whether or not the measure for deleting the already stored data is selected, based on the input information from the operation panel 63. If the data management processing part 51 determines that the measure for deleting the already stored data is selected, the procedure goes to step S123. Also, if the data management processing part 51 determines that the measure for moving the already stored data to the server is selected, the procedure goes to step S128.

At following steps S123 and S124, the data management processing part 51 acquires the information of selected data based on the input information from the operation panel 63, until determining that the user performs an operation of ending the selection of data to be deleted, for example, until the user performs an operation of ending or deciding the selection of data on the operation panel 63. And if the data management processing part 51 determines that the selection of data is ended, the procedure goes to step S125.

At step S125, the data management processing part 51 deletes the data selected at step S123 among the already stored data within the storage medium 100.

At next step S126, the data management processing part 51 acquires the information on the free space of the storage medium 100 in the same way as at step S29.

At next step S127, the data management processing part 51 determines whether or not the data size of image data saved in the HDD 67 is null in the same way as at step S30. If the data management processing part 51 determines that the data size of image data saved in the HDD 67 is null, the process starts again from step S14 to read the original. Also, if the data management processing part 51 determines that the data size of image data saved in the HDD 67 is not null, the process starts again from step S18.

On the other hand, at steps S128 and S129, the data management processing part 51 acquires the information of selected data based on the input information from the operation panel 63, until determining that the user performs an operation of ending the selection of data to be sent to the server, for example, until the user performs an operation of ending or deciding the selection of data on the operation panel 63. And if the data management processing part 51 determines that the selection of data is ended, the procedure goes to step S130.

The processing of steps S128 and S129 is described later in detail.

At step S130, the data management processing part 51 performs an operation of moving (sending) the data selected at step S128 to the server 20 in the same way as at step S28 (see FIG. 4). And the data management processing part 51 makes forward to step S126.

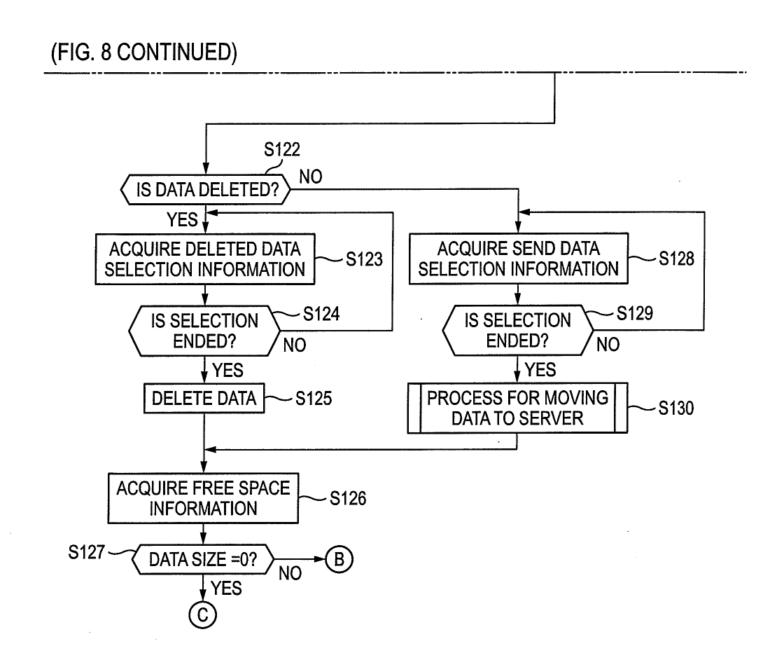

FIG. 9 is a flowchart showing a specific example of processing at steps S128 and S129 (in which the measure for sending the data to the server is selected).

At step S151, first of all, the data management processing part 51 displays a setting screen for enabling the user to set the data sending method on the display section 63a of the operation panel 63, as shown in FIG. 9. Herein, the method for sending all or part of the already stored data in the storage medium is selectably displayed on the setting screen.

At next step S152, the data management processing part 51 determines whether or not the method for sending all of the already stored data within the storage medium is selected, based on the input information from the operation panel 63. If the data management processing part 51 determines that the method for sending all of the already stored data is selected, the procedure goes to step S153. Also, if the data management processing part 51 determines that the method for sending part of the already stored data is selected, the procedure goes to step S157.

At step S153, the data management processing part 51 selects all of the already stored data within the storage medium 100.

At next step S154, the data management processing part 51 displays the list of data selected at the previous step on the display section 63a of the operation panel 63.

At next step S155, the data management processing part 51 displays the capacity of the storage medium 100 in sending the data displayed in the list at step S154 to the server 20 (deleting it from the storage medium 100) on the display section 63a of the operation panel 63 in terms of character or figure.

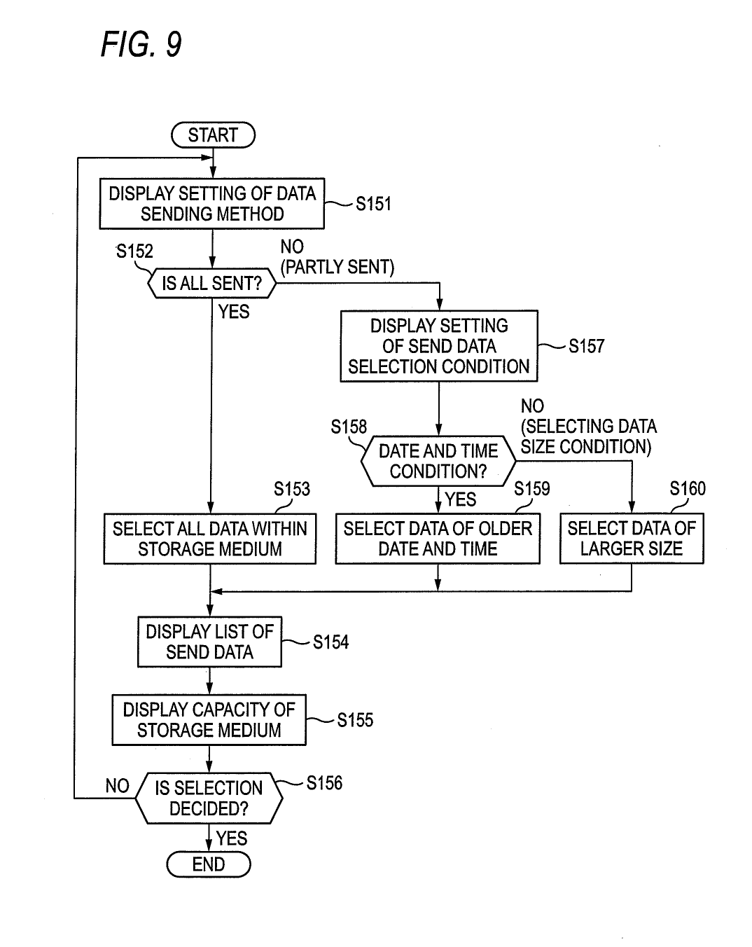

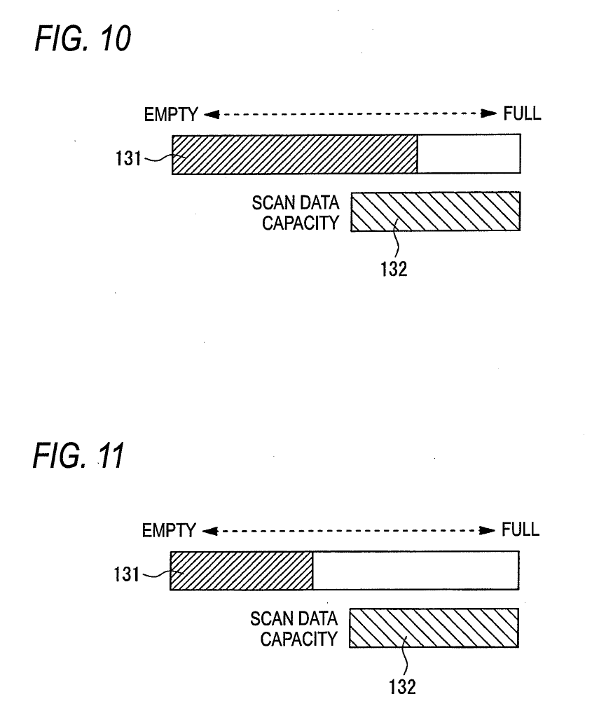

FIGS. 10 and 11 show the display examples.

FIG. 10 shows a display example in which a level 131 indicating the free space of the storage medium 100 after sending the data is smaller than a level 132 indicating the data size of image data. Also, FIG. 11 shows a display example in which the level 131 indicating the free space of the storage medium 100 after sending the data is larger than the level 132 indicating the data size of image data.

At next step S156, the data management processing part 51 determines whether or not the user performs an operation of deciding the selection, based on the input information from the operation panel 63. If the data management processing part 51 determines that the user performs the operation of deciding the selection, the process of FIG. 9 (steps S128 and S129) is ended. Thereby, the data management processing part 51 makes forward to the processing of step S130. Also, if the data management processing part 51 determines that the user does not perform the operation of deciding the selection, for example, when the user seeing the display of FIG. 10 retries the selection of data from the beginning, the process starts again from step S151.

At step S157, the data management processing part 51 displays a setting screen for enabling the user to select the selection condition of data to be sent on the display section 63a of the operation panel 63. Herein, the setting screen is displayed so that the user may select either the data and time or the data size as the condition.

At next step S158, the data management processing part 51 determines whether or not the date and time is selected as the condition based on the input information from the operation panel 63. If the data management processing part 51 determines that the date and time is selected, the procedure goes to step S159. Also, if the data management processing part 51 determines that the data size is selected, the procedure goes to step S160.

At step S159, the data management processing part 51 selects the data of the older date and time under the preset condition of the number or term (e.g., initialization condition made by the manager). And the data management processing part 51 makes forward to step S154. Thereby, at step S154, the data management processing part 51 displays the list of data selected under the condition of date and time on the display section 63a of the operation panel 63.

At step S160, the data management processing part 51 selects the data of larger size under the preset condition of the data size (e.g., initialization condition made by the manager). And the data management processing part 51 makes forward to step S154. Thereby, at step S154, the data management processing part 51 displays the list of data selected under the condition of the data size on the display section 63a of the operation panel 63.

The image processing system of the second embodiment is configured as above, and the operation is as follows.

Particularly in the second embodiment, the image processing apparatus 10 enables the user to select the storage medium or the server as the storage destination of image data, and performs a process for moving (sending) the image data to the server 20 from the beginning of the process, when the user selects the server as the storage destination of image data (steps S111 to S115, see FIG. 4).

Also, if the user selects the storage medium as the storage destination of image data, the image processing apparatus 10 enables the user to select operationally deleting the already stored data within the storage medium or moving the already stored data to the server (steps S121 and S122). More specifically, the image processing apparatus 10 enables the user to select deleting the already stored data within the storage medium or moving the already stored data to the server as the measure for securing the free space, if the free space of the storage medium 100 is null or the free space of the storage medium 100 is smaller than the data size of image data (steps S121 and S122).

Thereby, the image processing apparatus 10 deletes the already stored data selected by the user among the already stored data within the storage medium 100 or moves it to the server 20 (steps S122 to S130).

Further, if moving the data to the server is selected as the measure for securing the free space, the image processing apparatus 10 enables the user to select operationally the condition of date and time or the data size (steps S128 and S129, see FIG. 9).

Thereby, the image processing apparatus 10 moves the already stored data selected in accordance with the condition selected by the user among the already stored data within the storage medium 100 to the server 20 (steps S122 to S130).

As described above, in the second embodiment, the image processing apparatus 10 displays the data list of already stored data within the storage medium 100 and reports that the image data may not be stored in the storage medium 100, if the data size of the image data is larger than the free space of the storage medium 100 (step S25).

At this time, the image processing apparatus 10 enables the user to select operationally deleting the already stored data within the storage medium 100 or moving the already stored data to the server (steps S121 and S122). Thereby, the image processing apparatus 10 deletes the already stored data selected by the user among the already stored data within the storage medium 100 or moves it to the server 20 (steps S122 to S130).

Thereby, the image processing apparatus 10 secures the storage medium 100 or the server 20 to be selectable as the storage location of image data, and secures the storage location of already stored data within the storage medium 100 without erasing the already stored data, even if the storage medium 10 is selected as the storage location of image data.

As a result, the user may acquire the image data as well without erasing it by moving the already stored data within the storage medium 100 to the server 20 (taking it out on the PC 30 later), even if the free space of the storage medium 100 is smaller.

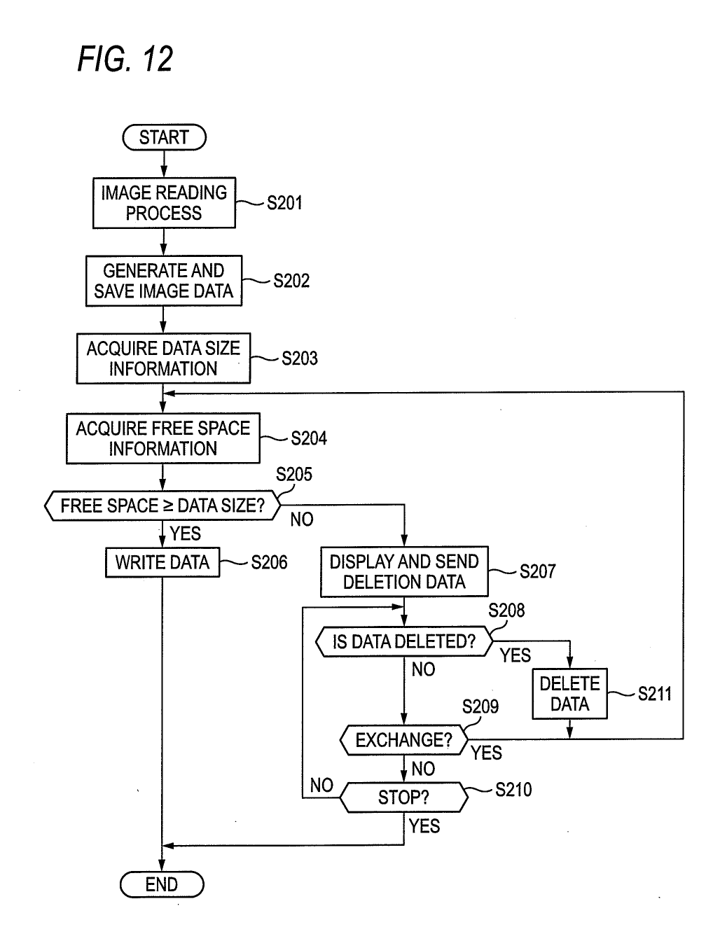

FIG. 12 is a flowchart showing a process of the image processing apparatus in a comparative example of this embodiment.

The image processing apparatus of the comparative example performs a process for reading the image, and generates and stores the image data (steps S201 and S202), as shown in FIG. 12. And the image processing apparatus of the comparative example acquires the information on the data size of the image data, and acquires the information on the free space of the storage medium (steps S203 and S204).

As a result, the image processing apparatus of the comparative example stores the image data in the storage medium such as an HDD, if the free space of the storage medium is larger than or equal to the data size of image data (steps S205 and S206). Also, if the free space of the storage medium is smaller than the data size of image data, the image processing apparatus of the comparative example performs a display process for deleting the already stored data within the storage medium (step S207), thereby deleting the already stored data within the storage medium (step S211), and if the storage medium is exchanged (step S209), the image processing apparatus performs the process again from acquiring the information on the free space of the storage medium (step S204). Also, the image processing apparatus of the comparative example ends the process if the stop is selected (step S210).

In this way, the image processing apparatus of the comparative example deletes the already stored data within the storage medium and then stores the image data in the storage medium, if the free space of the storage medium is smaller.

However, with this configuration, if the already stored data within the storage medium may not be deleted because it is important, the image data may not be stored in the storage medium. That is, the user may not acquire the image data.

Unlike this comparative example, the image processing apparatus of this embodiment may secure the storage location of the already stored data within the storage medium 100, even if the storage medium 100 is selected as the storage location of image data. Hence, the user may acquire the image data without erasing it by moving the already stored data within the storage medium 100 to the server 20, even if the free space of the storage medium 100 is smaller.

Also, the image processing apparatus 10 deletes a selected part of the already stored data within the storage medium, or moves it to the server 20, as previously described (steps S123, S124, S128 and S129).

Thereby, from the viewpoint of importance, the user may delete part of the already stored data within the storage medium 100 or move it to the server 20, as needed.

Also, the image processing apparatus 10 enables the user to select the condition for the data to be selected, and moves the already stored data within the storage medium 100 to the server 20 based on the selected condition, as previously described (FIG. 9).

Thereby, the image processing apparatus 10 may select the data according to the user's intention and move it to the server 20 in a shorter time than without setting such condition.

In the previous embodiment, the storage medium I/F 64 is employed as sending/receiving means. Also, the image reading part 61 is employed as acquisition means. Also, the operation panel 63 is employed as selection means. Also, the data management processing part 51 is employed as data processing means. Also, the storage medium such as the storage medium 100 is employed as portable storage means.

A variation of the previous embodiment is given as follows.

As the variation of the embodiment, the image processing apparatus 10 may have a function as the server 20.

Also, as the variation of the embodiment, the user may select the condition of data to be deleted (e.g., data size or date and time) in the case of deleting the already stored data from the storage medium 100.

Thereby, the image processing apparatus 10 may select and delete the data according to the user's intention in a shorter time than without setting such condition.

Also, as the variation of the embodiment, it may be possible to delete part of the already stored data within the storage medium 100 and move another part of the already stored data within the storage medium 100 to the server 20 in accordance with a selection of the user.

Also, as the variation of the embodiment, the storage medium 100 may be any other media, for example, smart media.

Also, as the variation of the embodiment, the data may be sent or received to or from the storage medium 100 by wireless.

Also, a control program for the computer capable of realizing various kinds of process as previously described may be provided by communication means 40 or provided in a form stored in the storage medium such as a CD-ROM.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments are chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A processing apparatus comprising:
an acquisition unit that acquires image data by reading an image from an original;
a selection unit that operationally selects either one of storing the image data into a portable storage unit or sending the image data to a storage device capable of taking out the data via a communication unit, wherein when the storing is selected, the selection unit further operationally selects at least any one of deleting data already stored in the portable storage unit and moving the image data to the storage device; and
a data processing unit that performs at least any one of deleting the data already stored in the portable storage unit and moving the image data to the storage device, and performs either one of storing the image data into the portable storage unit or sending the image data to the storage device, based on result selected by the selection unit.

2. The processing apparatus according to claim 1, wherein the selection unit operationally selects at least any one of deleting the image data stored in the portable storage unit and moving the image data to the storage device if data size of the image data is larger than free space of the portable storage unit.

3. The processing apparatus according to claim 1, wherein the selection unit operationally selects at least any one of deleting a part of data already stored in the portable storage unit and moving the part of data already stored in the portable storage unit to the storage device.

4. The processing apparatus according to claim 1, further comprising:
a move condition setting unit that operationally sets a condition of moving the data to the storage device, wherein the data processing unit selects the data already stored in the portable storage unit and moves the image data to the storage device, based on the condition set by the move condition setting unit.

5. The processing apparatus according to claim 1, further comprising:
a deletion condition setting unit that operationally sets a condition of deleting the data from the portable storage unit, wherein the data processing unit selects and deletes the data stored in the portable storage unit, based on the condition set by the deletion condition setting unit.

6. A non-transitory computer readable medium storing a program for control, the process comprising:
acquiring image data by reading an image from an original;
operationally selecting either one of storing the image data into a portable storage unit or sending the image data to a storage device capable of taking out the data via a communication unit, wherein when the storing is selected, further operationally selecting at least any one of deleting data already stored in the portable storage unit and moving the image data to the storage device; and
performing at least any one of deleting the data already stored in the portable storage unit and moving the image data to the storage device, and performing either one of storing the image data into the portable storage unit or sending the image data to the storage device, based on result selected by the selection unit.

7. The process according to claim 6, wherein the selecting carries out at least any one of deleting the image data stored in the portable storage unit and moving the image data to the storage device if data size of the image data is larger than free space of the portable storage unit.

8. The process according to claim 6, wherein the selecting carries out at least any one of deleting a part of data already stored in the portable storage unit and moving the part of data already stored in the portable storage unit to the storage device.

9. The process according to claim 6, further comprising:
operationally setting a condition of moving the data to the storage device so as to select the data already stored in the portable storage unit and move the image data to the storage device, based on the condition set by the move condition setting unit.

10. The process according to claim 6, further comprising:
operationally setting a condition of deleting the data from the portable storage unit select and delete the data stored in the portable storage unit, based on the condition set by the deletion condition setting unit.
